(19) United States
(12) Patent Application Publication
(10) Pub. No.: US 2026/0229872 A1
(43) Pub. Date: Aug. 6, 2026

(54) SELECTABLE SHUNT VOLTAGE FOR CIRCUIT BREAKER

(71) Applicant: Vertiv Corporation, Westerville, OH (US)

(72) Inventors: Taylor Zigon, Dublin, OH (US); Jason David Peltier, Dublin, OH (US); Thomas Lammers, Lewis Center, OH (US)

(21) Appl. No.: 19/456,595

(22) Filed: Jan. 22, 2026

Related U.S. Application Data
(60) Provisional application No. 63/753,232, filed on Feb. 3, 2025.

(51) Int. Cl. H02H 3/32; H02H 1/00

(52) U.S. Cl. CPC H02H 3/325; H02H 1/0061

(57) ABSTRACT

A system for operating a circuit breaker is disclosed. The system includes a shunt coil configured to trip a circuit breaker. A first voltage source is configured to produce a first voltage and second voltage source configured to produce a second voltage. A voltage selection circuit configured to select one of the first and second voltage sources. A shunt drive circuit configured to drive an actuation voltage to the shunt coil based on a selected one of the first and second voltages.

### CROSS-REFERENCE TO RELATED APPLICATIONS

This application claims the benefit of U.S. Provisional Application No. 63/753,232, filed on February 3, 2025. The entire disclosure of the application referenced above is incorporated herein by reference.

### TECHNICAL FIELD

This disclosure is directed to electrical systems, and more particularly, to the control of circuit breakers.

### BACKGROUND

A shunt coil, or shunt trip coil, is an electrical component used to automatically trip a circuit breaker in an electrical system. The shunt coil may allow the breaker to be tripped in response to specific conditions or a remote command. Shunt coils work in conjunction with a shunt trip drive circuit. A typical shunt trip drive circuit operates with a particular drive voltage, which is provided by a corresponding voltage source.

### SUMMARY

A system for operating a circuit breaker is disclosed. The system includes a shunt coil configured to trip a circuit breaker. A first voltage source is configured to produce a first voltage and second voltage source configured to produce a second voltage. A voltage selection circuit configured to select one of the first and second voltage sources. A shunt drive circuit configured to drive an actuation voltage to the shunt coil based on a selected one of the first and second voltages.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a block diagram illustrating a system having a selectable voltage shunt coil.

FIG. 2 is a block diagram illustrating another system having a selectable voltage shunt coil.

FIG. 3 is a flow diagram of a method for operating a circuit breaker using a selectable voltage shunt coil.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names – this document does not intend to distinguish between components that differ in name but not function.

Matters of these example embodiments that are obvious to those of ordinary skill in the technical field to which these example embodiments pertain may not be described herein in detail.

Shunt drive circuits are typically rated for a single voltage, having a set voltage level dependent on corresponding ratings of selected shunt trip coils. For example, a 24 V shunt coil requires 24 volts to operate properly. However, due to variations in customer’s needs, an alternate shunt trip coils may be desired that operate at a different voltage level than what the system was originally designed for or what shunt driver circuits are available. The present disclosure adds a customer/service selectable parameter to shunt trip drive circuits to allow for the output of one of two or more common voltage levels for shunt trip coils.

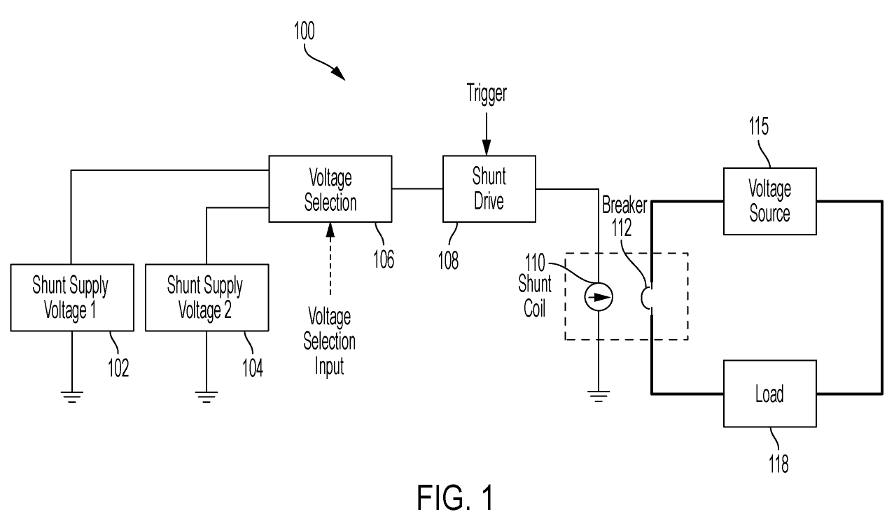

FIG. 1 is a block diagram illustrating a system having a selectable voltage shunt coil. In the illustrated example, system 100 includes a shunt driver circuit 108 which may receive one of at least two different voltages. A first voltage is provided by supply voltage source 102, while a second voltage is provided by supply voltage source 104. It is noted that only two voltage sources are shown here by way of example, but the disclosure is not limited in this manner. Accordingly, embodiments are possible and contemplated in which more than two voltage sources may be present, as well as embodiments in which an individual voltage source can generate two or more voltages.

Voltage selection circuit 106 in the illustrated example is configured to select one of the voltage sources to provide a source voltage to shunt drive circuit 108. The selection may be made in accordance with a voltage selection input, which may be a manual input from a user or an input provided via, e.g., a control circuit or the like.

Shunt driver circuit 108 is coupled to receive the source voltage selected by voltage selection circuit 106. When a trigger signal is asserted, shunt driver circuit 108 generates, based on the received source voltage, an actuation voltage that is provided to shunt coil 110. In response to receiving the actuation voltage, shunt coil 110 causes circuit breaker 112 to open, thereby breaking the circuit between voltage source 115 and load circuit 118.

The trigger signal may be asserted by a control circuit (not shown) that may monitor conditions of voltage source 115 and load circuit 118. The assertion of the trigger signal may be in response to detection of conditions that would lead to unsafe operation of load circuit 118 or voltage source 115, an emergency indication (e.g., a fire alarm) in the facility in which load circuit 118 and/or voltage source 115 are located. The disclosure further contemplates that the trigger signal may be asserted in response to a user input, e.g., when planned maintenance is to be carried out on load circuit 118.

Shunt driver circuit 108 may carry out additional functions, such as ensuring that the actuation voltage signal is properly conditioned to cause shunt coil activation. Proper conditioning may include ensuring the actuation voltage is provided at the proper level and with a sufficient amount of current. Shunt driver circuit 108 may also protect shunt coil 110 from overvoltage or undervoltage conditions that may otherwise lead to malfunctions and/or damage. Some embodiments of shunt drive circuit 108 may also include filter circuits that, e.g., prevent unintended tripping of circuit breaker 112 due to transient conditions that are not sufficient in duration to lead to damage to either voltage source 115 or load circuit 118. In embodiments in which the source voltages are AC voltages while the actuation is a DC voltage, shunt driver circuit 108 may perform rectification and conversion to DC.

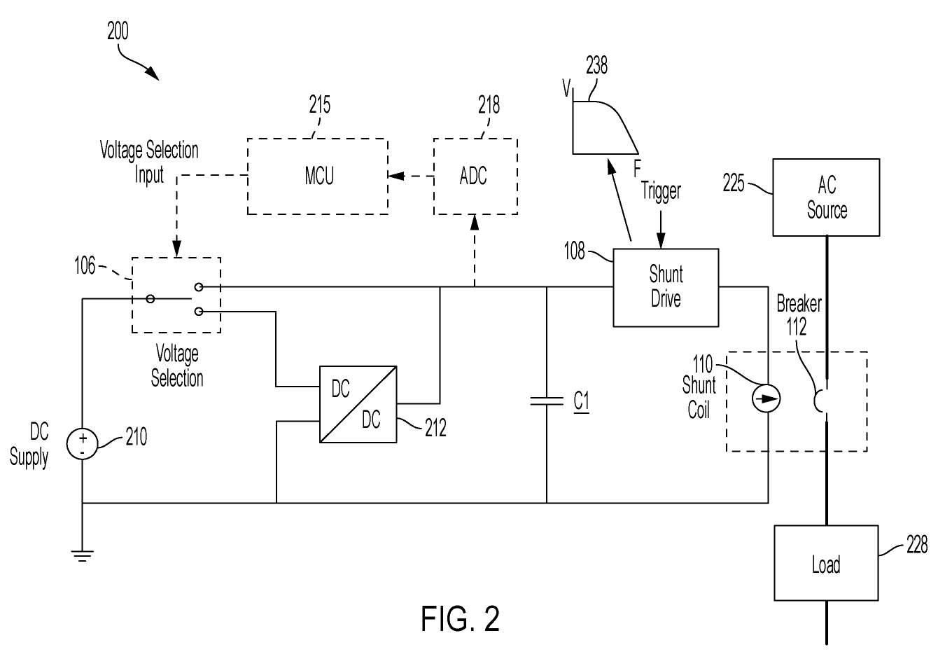

FIG. 2 is a block diagram illustrating another system having a selectable voltage shunt coil. In this embodiment, voltage selection circuit 106 is coupled to receive a DC voltage from DC supply 210. Depending the state of the voltage selection input, the DC voltage from DC source 210 may provide the voltage from DC supply 210 directly to shunt drive circuit 108 or as an input voltage to DC-DC converter 212. DC-DC converter 212 may, when receiving the voltage from DC supply 210, generate the shunt voltage provided to shunt drive circuit 108. The voltage generated by DC-DC converter 212 may be a boost converter or a buck converter. The disclosure further contemplates embodiments in which DC-DC converter is capable of generating voltages at two or more discrete levels, or within a continuum of different voltage levels such that additional flexibility is obtained.

In this particular example, shunt coil 110 is configured to operate a circuit breaker 112 that is coupled between an AC source 225 and a load circuit 228. However, this is a non-limiting example, and the configuration of system 200 is contemplated as being used with a load circuit coupled to a DC voltage source.

Shunt drive circuit as shown here includes a filter circuit 238. In one embodiment, this filter may be implemented as a low-pass filter. The use of a filter may prevent high-frequency, short-lived transients from causing the tripping of circuit breaker 112 when the transients do not pose a danger to the load circuit 228, the AC source 225, or personnel in the vicinity.

System 200 as shown here also includes an analog-to-digital converter (ADC) 218 and a control circuit 215 that is configured to generate the voltage selection input. ADC 218 may convert the voltage present on the input to a digital value that is provided control circuit 215. This allows control circuit 215 to monitor the voltage present on the input to shunt drive circuit 108. Accordingly, control circuit 215 may verify that this voltage is within specified limits, and may generate an indication if not, thereby allowing a technician to take appropriate action.

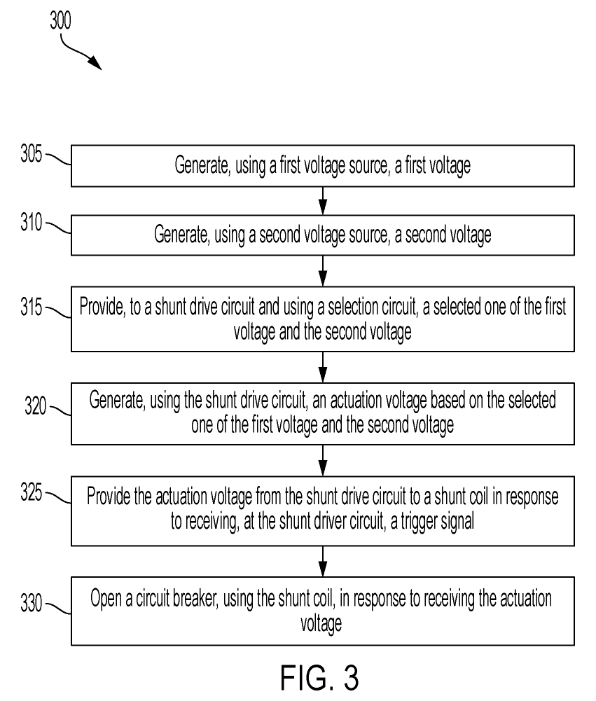

FIG. 3 is a flow diagram of a method for operating a circuit breaker using a selectable voltage shunt coil. Method 300 may be carried out using various embodiments of the systems discussed above, as well as with others not explicitly discussed herein.

Method 300 includes generating, using a first voltage source, a first voltage (block 305), and generating, using a second voltage source, a second voltage (block 310). Various sources may be used to generate the first and second voltages, which may be AC or DC voltages. Furthermore, additional voltages may be generated using additional voltage sources. The disclosure further contemplates that some voltage sources may have an adjustable voltage output that may vary according to an input (e.g., such as a user selection).

Method 300 further includes providing, to a shunt drive circuit and using a selection circuit, a selected one of the first voltage and the second voltage (block 315). The voltage may be selected using a selection circuit, such as one of those discussed above. In embodiments in which an adjustable voltage source is present, one or more signals may be provided thereto to select the desired voltage. The shunt drive circuit may generate an actuation voltage based on the selected one of the first and second voltages (block 320). In response to receiving a trigger signal, the shunt drive circuit provides the actuation voltage to a shunt coil (block 325). In response to receiving the actuation voltage, the shunt coil causes the opening of a circuit breaker (block 330).

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A system for operating a circuit breaker, the system comprising:
a shunt coil configured to trip the circuit breaker;
a first voltage source configured to produce a first voltage and second voltage source configured to produce a second voltage;
a voltage selection circuit configured to select one of the first and second voltage sources; and
a shunt drive circuit configured to drive an actuation voltage to the shunt coil based on a selected one of the first and second voltages.

2. The system of claim 1, further comprising, wherein the first voltage source comprises a first DC voltage supply, and wherein the second voltage source comprises a DC-DC converter configured to use the first voltage to generate the second voltage.

3. The system of claim 2, wherein the DC-DC converter is configured to generate the second voltage at a level greater than that of the first voltage.

4. The system of claim 1, further comprising a control circuit configured to generate a control signal to cause the voltage selection circuit to select one of the first and second voltage sources.

5. The system of claim 4, further comprising an analog-to-digital converter configured to generate a digital value corresponding to the selected one of the first and second voltages, and further configured to provide the digital value to the control circuit.

6. The system of claim 5, wherein the control circuit is configured to verify that the selected one of the first and second voltages is within specified limits.

7. The system of claim 1, wherein the shunt drive circuit is configured to regulate, based on the selected one of the first and second voltage sources, a voltage level provided to the shunt coil.

8. The system of claim 7, wherein the shunt drive circuit is configured to cause the shunt coil to open the circuit breaker in response to receiving a trip signal, wherein to cause the shunt coil to open the circuit breaker, the shunt drive circuit is configured to provide the actuation voltage to the shunt coil.

9. The system of claim 8, wherein the shunt drive circuit includes a filter configured to filter the trip signal.

10. A method comprising:
generating, using a first voltage source, a first voltage;
generating, using a second voltage source, a second voltage;
providing, to a shunt drive circuit and using a selection circuit, a selected one of the first voltage and the second voltage;
generating, using the shunt drive circuit, an actuation voltage based on the selected one of the first voltage and the second voltage;
providing the actuation voltage from the shunt drive circuit to a shunt coil in response to receiving, at the shunt drive circuit, a trigger signal; and
opening a circuit breaker, using the shunt coil, in response to receiving the actuation voltage.

11. The method of claim 10, wherein generating the second voltage comprises using a DC-DC converter to generate the second voltage using the first voltage.

12. The method of claim 11, further comprising the DC-DC converter generating the second voltage at a level greater than the first voltage.

13. The method of claim 10, further comprising generating a control signal to cause the selection circuit to select one of the first and second voltages.

14. The method of claim 13, further comprising generating a digital value corresponding to the selected one of the first voltage and the second voltage and providing the digital value to a control circuit.

15. The method of claim 14, further comprising verifying, using the control circuit, that the selected one of the first voltage and the second voltage is within specified limits.

16. The method of claim 10, further comprising regulating, using the shunt drive circuit, a voltage level provided to the shunt coil based on the selected one of the first and second voltages.

17. The method of claim 16, further comprising causing the shunt coil to open the circuit breaker in response to receiving a trip signal by providing the actuation voltage to the shunt coil.

18. The method of claim 17, further comprising filtering the trip signal before providing the actuation voltage to the shunt coil.

19. A system for operating a circuit breaker, the system comprising:
a circuit breaker coupled between an AC source and a load circuit;
a shunt coil configured to trip the circuit breaker;
a DC supply configured to produce a first DC voltage;
a DC-DC converter configured to receive the first DC voltage from the DC supply and generate a second DC voltage;
a voltage selection circuit configured to select one of the first DC voltage from the DC supply and the second DC voltage from the DC-DC converter in response to a voltage selection input; and
a shunt drive circuit configured to receive a selected one of the first DC voltage and the second DC voltage from the voltage selection circuit and further configured to drive an actuation voltage to the shunt coil based on the selected voltage in response to a trigger signal.

20. The system of claim 19, further comprising:
an analog-to-digital converter configured to convert the selected voltage to a digital value;
a control circuit configured to receive the digital value from the analog-to-digital converter and to generate the voltage selection input for the voltage selection circuit; and
a filter circuit configured to filter the trigger signal before the trigger signal is provided to the shunt drive circuit.
